(19) United States
(12) Patent Application Publication
(10) Pub. No.: US 2012/0104008 A1
(43) Pub. Date: May 3, 2012

(54) Liquefied Gas Evacuation Assembly System for Underground Storage Tanks

(76) Inventors: Joseph Lee DeNardo, Bayfield, CO (US); Seth Hofman, Bayfield, CO (US)

(21) Appl. No.: 13/014,537

(22) Filed: Jan. 26, 2011

Related U.S. Application Data
(60) Provisional application No. 61/409,630, filed on Nov. 3, 2010.

(51) Int. Cl. B65D 90/00; F15D 1/00

(52) U.S. Cl. 220/694; 137/1

(57) ABSTRACT

An evacuation assembly for empting underground tanks of liquefied gas. The assembly not only provides ease of attaching a coupling to the underground tanks but also increases the safety of the individual attaching the coupling to the underground tank. The evacuation assembly uses a riser extension with a rotatable hose coupling mechanism to allow the coupling to be easily attached to the underground tank without the individual being exposed to volatile vapors that may have accumulated in the dome of the underground tank.

### RELATED APPLICATIONS

This application claims benefit of provisional Ser. No. 61/409,630 filed Nov. 3, 2010.

### FIELD OF THE INVENTION

This invention relates to the field of liquefied gas evacuation assemblies and particularly for servicing of underground tanks or other difficult to access tanks.

### BACKGROUND OF THE INVENTION

Propane is commonly used for residential, commercial and industrial heating systems. It is derived from the refining of oil and gas and is compressible to a liquid form for storage. It is generally transported from central storage locations to a storage tank nearby the point of use. The propane is stored prior to use in tanks typically between five hundred to one thousand gallons in liquid form. Trucks are normally used to transport the liquefied propane from a storage location to the tanks. The liquefied propane is delivered by a hose connected from the truck tank to the storage tank. The hose end includes a coupling that is screwed onto the tank fill valve. Once the valve on the hose is opened which then allows the liquefied propane to enter the tank fill valve. The pressure of the liquefied propane from the delivery truck tank will then open the one way valves in the tank fill valve to fill the storage tank.

The storage tanks can be above ground for ease of filling, but underground storage tanks are becoming more popular. The typical underground storage tank, such as the underground storage tank shown in FIG. 1, includes a dome that extends from the tank to above the ground to protect and allow access to the fill valve, regulator assembly, safety valve, fill gauge and liquid withdrawal valve for the tank. Since propane vapor is generally heavier than air, it can settle and accumulate in the dome from escape during the fill process, or during times of hot weather.

A serious problem arises when the storage tank is evacuated. Often it becomes necessary to empty the storage tank, such as for an emergency, such as fire; for maintenance and repair of the tank; for transfer of ownership of the tank; or for other reasons. Most propane tanks have a liquid withdrawal valve referred to as an actuated liquid withdrawal excess valve. This valve includes a dip tube extending into the bottom of the tank with a powerful spring holding a seat disc in a closed position. The seat disc is opened by attaching a second valve to the exterior of the liquid withdrawal excess valve. The liquid withdrawal excess valve is generally located beneath the regulator and/or fill valve. The service technician is forced to reach deep within the dome of the underground storage tank to access the liquid withdrawal valve and attach the secondary valve. This creates a dangerous situation for the technician in exposing their face and body directly in and over the dome to any volatile vapors that may have accumulated or that may escape during the evacuation process. Often, volatile vapors are released during the attachment or removal of the secondary valve from the liquid withdrawal valve, during the fill process, and during periods of hot weather when expanding pressure in the tank is released by the safety valve. Presently, the service technicians must kneel or lie down and reach into the dome of underground storage tanks to attach and remove the secondary valve which exposes them to any volatile vapors that may have accumulated or are released.

Problems can also arise during the filling of the storage tank. The underground storage tank is filled by attaching an adapter coupling to the fill valve. The opposing end of the adapter coupling is attached to a hose that leads to a fill tank mounted onto a truck. The higher pressure of the fill tank will cause liquefied gas to transfer to the storage tank. Once the storage tank has been filled to the desired level, the adapter coupling is removed from the fill valve and removed from the dome.

The location of the dome and the fill valve require the service technician to kneel over the dome to insert the hose and adapter coupling to the fill valve of the storage tank, and then rotate the adapter coupling to tighten the adapter coupling onto the fill valve. This is not only uncomfortable for the service technician but also places the service technician at great risk. There is opportunity for the vapors from the liquefied gas to accumulate in the dome either during the fill operation, during the dis-attachment of the adapter coupling from the fill valve or during release of the safety valve due to over pressurization of the gas in the tank. Since the service technician is forced to kneel over the dome during the attachment and release of the adapter coupling, the technician is exposed to any gas vapor that may have accumulated in the dome. This can lead to respiratory problems as well as the risk of the ignition of the gases which could be very dangerous and risky to the technician.

### SUMMARY OF THE INVENTION

The present invention provides an evacuation assembly for transferring liquefied gas from an underground storage tank to a truck or other tank. The assembly may also be used with storage tanks that may be in an awkward locations. The present invention not only increases the safety to the service technician evacuating the storage tank, but also provides greater ease and efficiency for the process of evacuating the storage tanks. The evacuation assembly of the present invention enables a service technician to connect and disconnect the secondary valve from a safe distance and without kneeling over the dome of the storage tank. The assembly also enables ease of connection and disconnection of the secondary valves to tanks in awkward locations.

The evacuation assembly of a preferred embodiment includes a hose coupling mechanism connected to a riser extension. The riser extension has a length that extends a sufficient distance so that the service technician does not have to kneel over the dome to connect the secondary valve coupling mounted on the riser extension to the liquid withdrawal valve of the storage tank. The service technician is thus not exposed to gas vapors that may have accumulated in the dome. The service technician also does not have to kneel over the dome to connect the secondary valve coupling to the liquid withdrawal valve.

Another preferred embodiment of the present invention uses a riser extension having an internal tube with threaded ends to attach the hose coupling and the secondary valve coupling. An external tube is mounted over the internal tube to provide protection to the internal tube as well as providing a gripping portion to enable the assembly to be easily rotated to connect the secondary valve coupling to the liquid withdrawal valve of the storage tank. Alternatively a single tube can be used in lieu of the double tube assembly.

In another preferred embodiment, the evacuation assembly uses a hose coupling mechanism mounted on a swivel fitting. The swivel fitting enables the hose coupling to be swiveled to orient to the hose from the fill tank. A ninety-degree elbow fitting may also be used to orient the hose coupling in a horizontal plane to more easily connect to the hose from the fill tank. A valve mechanism may also be included to allow a quick shut-off of the liquefied gas through the riser extension if needed and to control the flow at the point.

In another preferred embodiment, the evacuation assembly may be used with an adaptor coupling that can be attached to the fill valve of the tank. This enables underground tanks to be safely filled without exposing the service technician to volatile vapors in the dome. This embodiment is similar to the above described embodiment with an adaptor coupling on the lower end of the riser assembly instead of the secondary valve.

These and other features of the present invention will be evident from the ensuing detailed description of preferred embodiments, from the drawings and from the claims.

### BRIEF DESCRIPTION OF THE DRAWINGS

FIG. 1 is a perspective cut-away view of an underground storage tank for liquefied gas.

FIG. 2 is a perspective view of the evacuation assembly of a preferred embodiment.

FIG. 3 is a detail view of the inner tube of the riser extension;

FIG. 4 is a detail view of the hose coupling mechanism;

FIG. 5 is a cut view of the evacuation assembly attached to an underground storage tank.

FIG. 6 is a cut away view of the evacuation assembly being used to fill an underground storage tank.

### DETAILED DESCRIPTION OF PREFERRED EMBODIMENTS

The present invention provides products and methods for safely transferring liquefied propane from storage tanks and in particular, to underground storage tanks. It is to be expressly understood that this exemplary embodiment is provided for descriptive purposes only and is not meant to unduly limit the scope of the present inventive concept. Other embodiments of the transfer assembly and methods of use of the present invention are considered within the present inventive concept as set forth in the claims herein. For explanatory purposes only, assembly and methods of use of the preferred embodiments are discussed primarily for the purposes of understanding the method of installation. It is to be expressly understood that other products and methods are contemplated for use with the present invention as well.

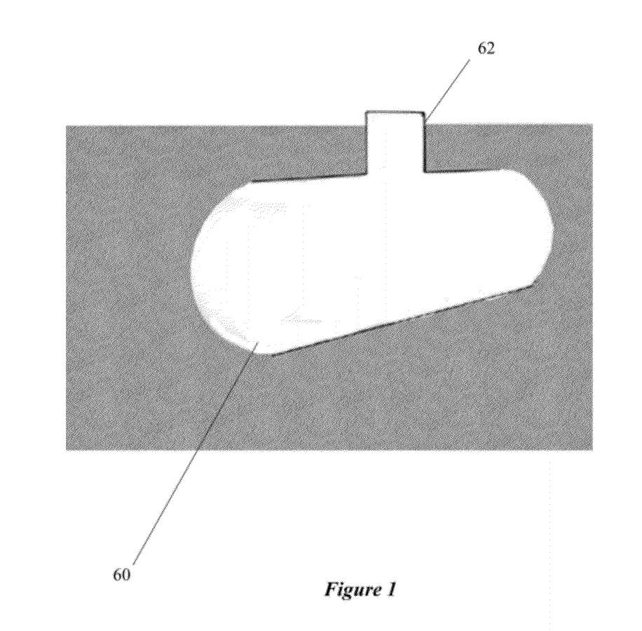

A preferred embodiment of the present invention utilizes an evacuation assembly for evacuating underground tanks with liquefied gas, such as propane as shown in FIG. 1. The assembly not only provides ease of attaching a coupling to the underground tanks but also increases the safety of the individual attaching the coupling to the underground tank. The preferred embodiment uses a riser extension with a rotatable hose coupling mechanism to allow the coupling to be easily attached to the underground tank without the individual being exposed to volatile vapors that may have accumulated in the dome of the underground tank.

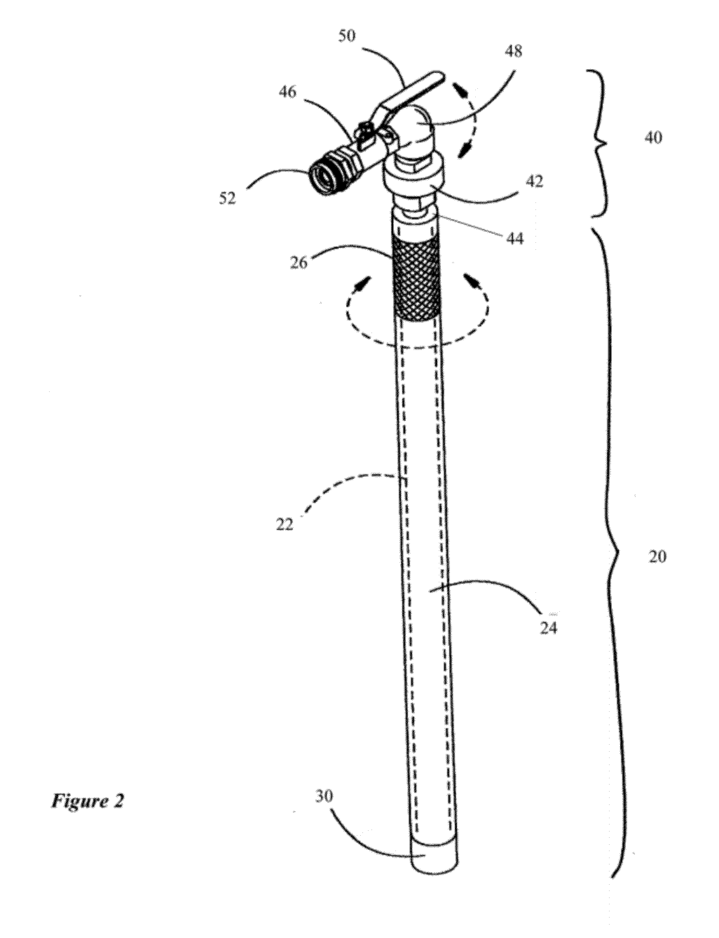

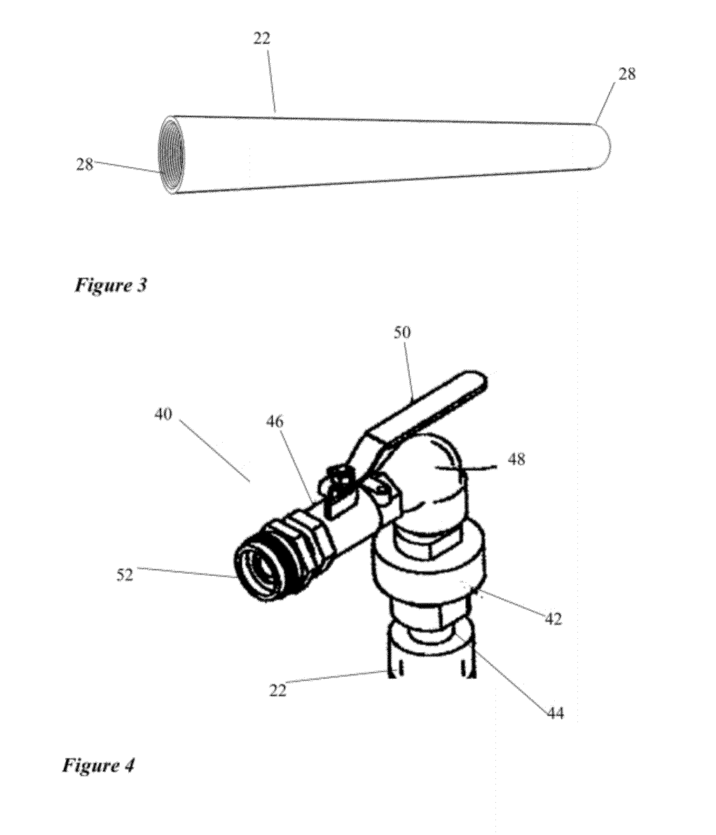

In a preferred embodiment, the assembly 10 as shown in FIG. 2 includes riser 20, adapter coupling 30 and hose coupling mechanism 40. The riser 20, in this preferred embodiment includes an internal pipe or tube 22, as shown in FIG. 3 preferably formed from a thick walled schedule 80 steel pipe, or other material that is able to be a safe conduit for liquefied gases. The length of the pipe is selected to allow the service technician using the assembly to operate the assembly at a safe distance from the dome of the storage tank. In one preferred embodiment, the length is approximately three feet, but other lengths could be used as well. The diameter of the pipe 22 is selected to securely fit the standard adapter coupling 30. Each end 28 of the pipe 22 is threaded to accept the adapter coupling 30 on one end and the hose coupling mechanism 40 on the other end. Alternatively, the adapter coupling 30 and hose coupling assembly may be fastened to the pipe by other mechanisms as well, such as welding, etc.

The riser of this embodiment also includes an external sleeve 24 shown in FIG. 2 that fits over the external surface of the pipe 22. The sleeve 24 preferably is formed of a thick walled material, such as steel or aluminum or even thick plastic, to provide protection from damage to the internal pipe 22. The sleeve 24 may also include knurled portions to provide secure gripping when the assembly is being attached or removed from the storage tank. The sleeve is securely attached to the internal pipe by threaded engagement, by welding or by other mechanisms. This ensures that as the sleeve 24 is rotated, the internal pipe 22 and adapter coupling 30 are rotated as well. The upper outer portion of the sleeve can be knurled or otherwise textured to create a gripping surface 26.

In an alternative embodiment, the sleeve 24 may take the place of the internal pipe 22. The adapter coupling 30 and valve assembly 40 are attached to the ends of the sleeve 24. The liquefied gas is conducted through the valve assembly 40 into the sleeve to the adapter coupling 30 in this embodiment.

The adapter coupling 30 is of standard design to attach to the liquid withdrawal valve of the underground propane tank. The coupling 30 includes a threaded end 32 that is inserted into the liquid withdrawal valve and rotated until the end engages against the seat disc of the liquid withdrawal valve to open the seat disc against the pressure of the spring to ensure the coupling is sealed. Failure of the seal can create escaped gas that accumulates in the dome of the tank. The gas can also accumulate in the dome during the disconnection of the coupling from the tank liquid withdrawal valve.

The hose coupling mechanism 40 shown in FIGS. 2 and 4 in the preferred embodiment, includes a swivel fitting 42. The lower end 44 of the swivel fitting 40 is secured in the upper end of the internal pipe 22 by threads or other mechanisms. The swivel fitting 42 is able to freely rotate relative to the internal pipe 22 while the lower end 44 is secured to the internal pipe 22. In this embodiment, a ninety-degree elbow pipe fitting 48 is attached to the upper end of the swivel fitting 40. This provides a horizontal plane for the valve and hose during the attachment process and the gas transfer process for ease of use. Valve 46 is attached to the elbow fitting (or directly to the swivel fitting in another embodiment). The valve 46 allows the service technician to start and stop the flow of gas into the assembly for safety purposes by rotation of handle 50. The valve can be omitted in another embodiment, with the flow of gas controlled at the site of the larger tank. Hose coupling 52 is attached to the valve 26 to allow the attachment of a hose to the assembly. The hose (not shown) is attached on the other end to the larger tank.

### Use

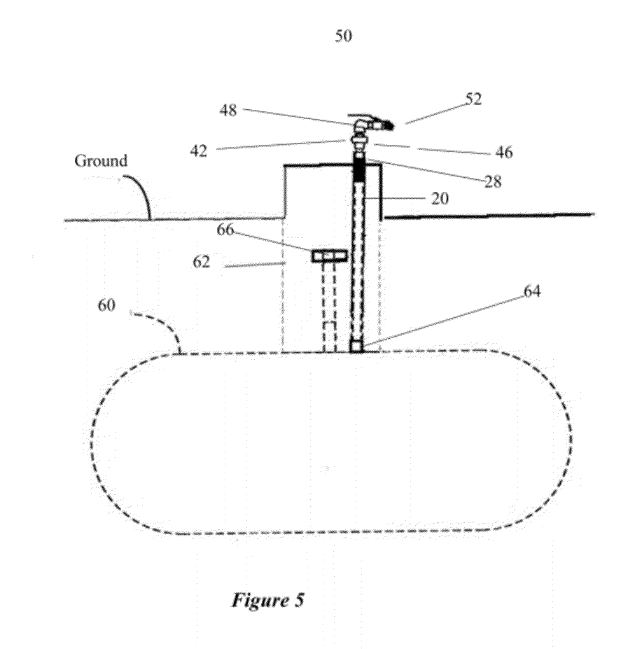

In use as shown in FIG. 5, the assembly 10 is inserted into the dome 62 of the underground tank 60 until the adapter coupling 30 engages the liquid withdrawal valve 64 of the propane tank. The adapter coupling 30 is rotated by the service technician grasping the outer sleeve 24 and rotating the riser 20. The rotation will engage the adapter coupling 30 with the liquid withdrawal valve. The continued rotation will push the seat disc against the internal spring to open the seat disc to allow vapor to escape and liquid to be pumped out of the storage tank.

The hose coupling mechanism 40 is then swiveled until it is in position to be coupled to the hose coupling of the fill tank. The hose coupling is attached to the hose coupling mechanism and the valve can be opened to start the evacuation process. Once the underground tank has been emptied, the valve can be closed, the hose uncoupled from the hose coupling mechanism, and the evacuation assembly detached from the underground tank liquid withdrawal valve.

Through this entire process, the service technician is able to stand away from the dome of the underground tank and in an upright position. Previous evacuation assemblies required the service technician to kneel or even lie on the ground directly over the dome where volatile gases may have accumulated. The present invention solves the discomfort from this prior process and even more importantly protects the service technician from danger from accumulated gases.

The evacuation assembly of the present invention may be formed in differing lengths, and in differing diameters depending on the application of the assembly. The assembly may also be used for above ground tanks as well, particularly those tanks in locations where the liquid evacuation valve is in an awkward position.

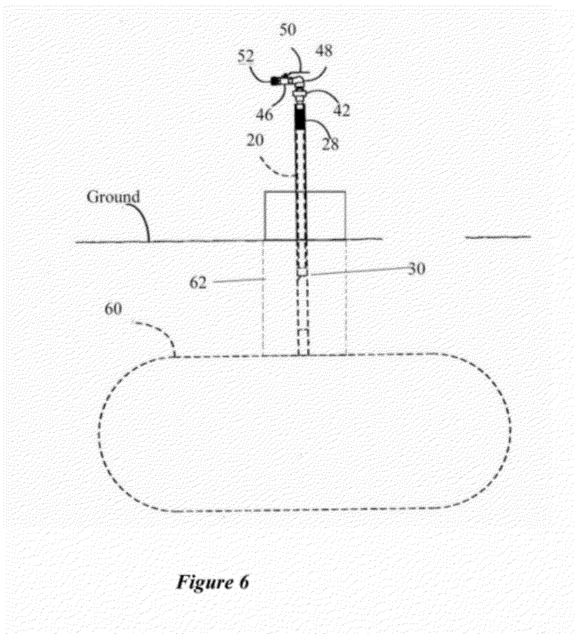

Another preferred embodiment of the present invention uses the evacuation assembly as a fill device. The adapter coupling 30 is replaced with an coupling for attachment to the fill valve 66 of a storage tank. The assembly is then attached in a manner similar to the above described process to attach the assembly to the fill tank so the underground tank can then be filled from another source as shown in FIG. 6.

It is to be expressly understood that the above descriptions of embodiments are provided only for explanatory purposes and are not meant to limit the scope of the claimed inventions.

What is claimed is:

1. An evacuation assembly for empting storage tanks of liquefied gas, said evacuation assembly comprising:
a hose coupling mechanism for attaching a hose from a secondary tank;
an elongated riser assembly attached to said hose coupling mechanism;
an adapter coupling for attachment to a liquid withdrawal valve on a storage tank attached to said elongated riser assembly.

2. The evacuation assembly of claim 1 wherein said elongated riser assembly includes:
a first elongated tube;
a threaded portion on one end of said first elongated tube for attachment to said hose coupling mechanism; and
a threaded portion on the opposing end of said first elongated tube for attachment to said adapter coupling.

3. The evacuation assembly of claim 2 wherein said elongated riser assembly includes:
a second elongated tube;
an inner diameter on said elongated tube greater than the outer diameter of said first elongated tube; and
an attachment mechanism for securing said second elongated tube over said first elongated tube.

4. The evacuation assembly of claim 1 wherein said elongated riser assembly includes:
a second elongated tube;
a gripping portion on said second elongated tube;
an inner diameter on said elongated tube greater than the outer diameter of said first elongated tube; and
an attachment mechanism for securing said second elongated tube over said first elongated tube.

5. The evacuation assembly of claim 1 wherein said hose coupling mechanism includes:
a swivel mechanism to allow said hose coupling mechanism to swivel relative to said riser assembly while remaining secured to said riser assembly.

6. The evacuation assembly of claim 1 wherein said hose coupling mechanism includes:
a valve mechanism to open and close the flow of liquefied gas through said riser assembly.

7. The evacuation assembly of claim wherein said hose coupling mechanism includes:
a ninety-degree elbow fitting to orient said hose coupling mechanism perpendicular to said riser assembly.

8. The evacuation assembly of claim 1 wherein said hose coupling mechanism includes:
a swivel mechanism to allow said hose coupling mechanism to swivel relative to said riser assembly while remaining secured to said riser assembly;
a valve mechanism to open and close the flow of liquefied gas through said riser assembly; and
a ninety-degree elbow fitting to orient said hose coupling mechanism perpendicular to said riser assembly.

9. The evacuation assembly of claim 1 wherein said evacuation assembly includes:
a first elongated tube on said riser assembly;
a threaded portion on one end of said first elongated tube for attachment to said hose coupling mechanism;
a threaded portion on the opposing end of said first elongated tube for attachment to said adapter coupling;
a second elongated tube on said riser assembly;
an inner diameter on said elongated tube greater than the outer diameter of said first elongated tube;
an attachment mechanism for securing said second elongated tube over said first elongated tube;
a swivel mechanism on said hose coupling mechanism to allow said hose coupling mechanism to swivel relative to said riser assembly while remaining secured to said riser assembly;
a valve mechanism on said hose coupling mechanism to open and close the flow of liquefied gas through said riser assembly; and
a ninety-degree elbow fitting on said hose coupling mechanism to orient said hose coupling mechanism perpendicular to said riser assembly.

10. An evacuation assembly for filling storage tanks with liquefied gas, said evacuation assembly comprising:
a hose coupling mechanism for attaching a hose from a fill tank;
an elongated riser assembly attached to said hose coupling mechanism;
a first elongated tube on said riser assembly;
a threaded portion on one end of said first elongated tube for attachment to said hose coupling mechanism;
a threaded portion on the opposing end of said first elongated tube for attachment to said adapter coupling;
a second elongated tube on said riser assembly;
an inner diameter on said elongated tube greater than the outer diameter of said first elongated tube;
an attachment mechanism for securing said second elongated tube over said first elongated tube; and
an adapter coupling for attachment to a liquid withdrawal valve on a storage tank attached to said elongated riser assembly.

11. The evacuation assembly of claim 10 where in said evacuation assembly further includes:
a swivel mechanism on said hose coupling mechanism to allow said hose coupling mechanism to swivel relative to said riser assembly while remaining secured to said riser assembly;
a valve mechanism on said hose coupling mechanism to open and close the flow of liquefied gas through said riser assembly; and
a ninety-degree elbow fitting on said hose coupling mechanism to orient said hose coupling mechanism perpendicular to said riser assembly.

12. The evacuation assembly of claim 10 wherein said evacuation assembly further includes:
a gripping portion on said second elongated tube.

13. A method for empting an underground tank of liquefied gas using an evacuation assembly having a hose coupling mechanism attached to an elongated riser assembly secured to a liquid withdrawal valve adapter coupling, said method comprising the steps of:
inserting said evacuation assembly into the dome of the underground storage tank until said adapter coupling engages the liquid withdrawal valve of the tank;
grasping said riser assembly;
rotating said riser assembly to engage said adapter coupling with the liquid withdrawal valve until said liquid withdrawal valve is opened;
attaching a hose from a secondary tank to said hose coupling mechanism; and
transferring liquefied gas from the secondary tank through said evacuation assembly from the storage tank.

14. The method of claim 13 wherein said method further includes:
providing a swivel mechanism in said hose coupling; and
swiveling said hose coupling to orient said hose coupling to the hose of the secondary tank.

15. The method of claim 13 wherein said method further includes:
providing a valve mechanism on said hose coupling to open and close the flow of the liquefied gas through said riser assembly.

16. The method of claim 13 wherein said method further includes:
providing a ninety-degree elbow fitting to said hose coupling mechanism to orient said hose coupling mechanism perpendicular to said riser assembly.

17. The method of claim 13 wherein said method further includes:
providing a second elongated tube over said first elongated tube to protect said first elongated tube.

18. The method of claim 13 wherein said method further includes:
providing a second elongated tube with a gripping portion over said first elongated tube.

19. The method of claim 13 wherein said method further includes:
shutting the flow of liquefied gas through said evacuation assembly off;
removing the hose from said hose coupling mechanism;
rotating said riser assembly to disengage said adapter coupling from said liquid withdrawal valve; and
removing said evacuation assembly from the dome of the storage tank.
